(19) United States
(12) Patent Application Publication
(10) Pub. No.: US 2016/0334036 A1
(43) Pub. Date: Nov. 17, 2016

(54) FLANGE SEAL

(71) Applicant: INTEGO INDUSTRIAL SAFETY LTD., Spruce Grove (CA)

(72) Inventor: Robert J. PARROTT, Spruce Grove (CA)

(21) Appl. No.: 15/154,095

(22) Filed: May 13, 2016

Related U.S. Application Data
(60) Provisional application No. 62/162,268, filed on May 15, 2015.

(51) Int. Cl. F16L 23/00

(52) U.S. Cl. CPC F16L 23/003

(57) ABSTRACT

A flange sealing system includes first and second bolt cups, each having a shackle and a flexible connector which passes through the shackle. The flexible connector may be attached to the bolt cups in a loop and shortened and locked so as to prevent a user from extending the length and accessing the bolt cups.

### FIELD OF THE INVENTION

The present invention relates to a device to seal a flange connection.

### BACKGROUND

Flange connections are common in piping systems and liquid and gas storage systems. For safety or anti-theft reasons, it is sometimes desirable to seal a flange connection together, A sealed flange connection may provide notice to those who wish to disconnect the flange connection that there may be safety issues, by creating a conscious and deliberate step to be undertaken before dismantling the connection.

### SUMMARY OF THE INVENTION

In one aspect, the invention comprises a flange sealing system comprising first and second bolt cups, each having at least one shackle and a flexible connector adapted to pass through the shackles, the flexible connector having an adjustable effective length to limit the distance between the two bolt cups . Preferably, the flexible connector is adapted to be locked when shortened to a locking length so as to prevent a user from extending the length.

### BRIEF DESCRIPTION OF THE DRAWINGS

The following drawings form part of the specification and are included to further demonstrate certain embodiments or various aspects of the invention. In some instances, embodiments of the invention can be well understood by referring to the accompanying drawings in combination with the detailed description presented herein. The description and accompanying drawings may highlight a certain specific example, or a certain aspect, of the invention. However, one skilled in the art will understand that portions of the example or aspect may be used in combination with other examples or aspects of the invention.

FIG. 1. A side view of a flange seal of the present invention installed on a flange connection.

FIG. 2. A top view of the flange seal of FIG. 1.

FIG. 3. A view of the flange seal of FIG. 1 from the other side.

FIG. 4. A bottom view of the flange seal of FIG. 1.

FIG. 5. A front side view of the flange seal of FIG. 1.

FIG. 6. A back side view of the flange seal of FIG. 1.

### DETAILED DESCRIPTION

As used herein, the recited terms have the following meanings. All other terms and phrases used in this specification have their ordinary meanings as one of skill in the art would understand.

In one broad embodiment, the invention comprises a flange connection sealing device (10) comprising a first bolt cup (12), a second bolt cup (14), and a flexible connector (16) attached to both the first and second cups, the flexible connector (16) having an adjustable effective length. When attached to both bolt cups and shortened to a locking length, the connector limits the distance between the two bolt cups. In one embodiment, the connector is adapted to be locked when shortened to a locking length so as to prevent a user from extending the length. In one embodiment, the flexible connector forms a loop routed around each bolt cup when installed, and the two ends of the flexible connector are locked together.

In one embodiment, the flexible connector (16) comprises a wire or cable, which is locked with a crimp connector (18). The crimp connector (18) cannot be disconnected without damaging it, or irreversibly altering it. Alternatively, the flexible connector (16) may comprise a plastic zip tie, or a similar configuration. In another alternative, the flexible connector (16) may comprise looped ends (not shown) which may be locked together with the shackle of a conventional pad lock or carabiner-style lock.

In one embodiment, the crimp connector may be stamped or otherwise marked with a unique identifier, such as a serial number, so that it would be apparent or discoverable if it were to be removed and replaced with another crimp connector. Accordingly, a record of removal or evidence of unplanned or unauthorized removal may be provided.

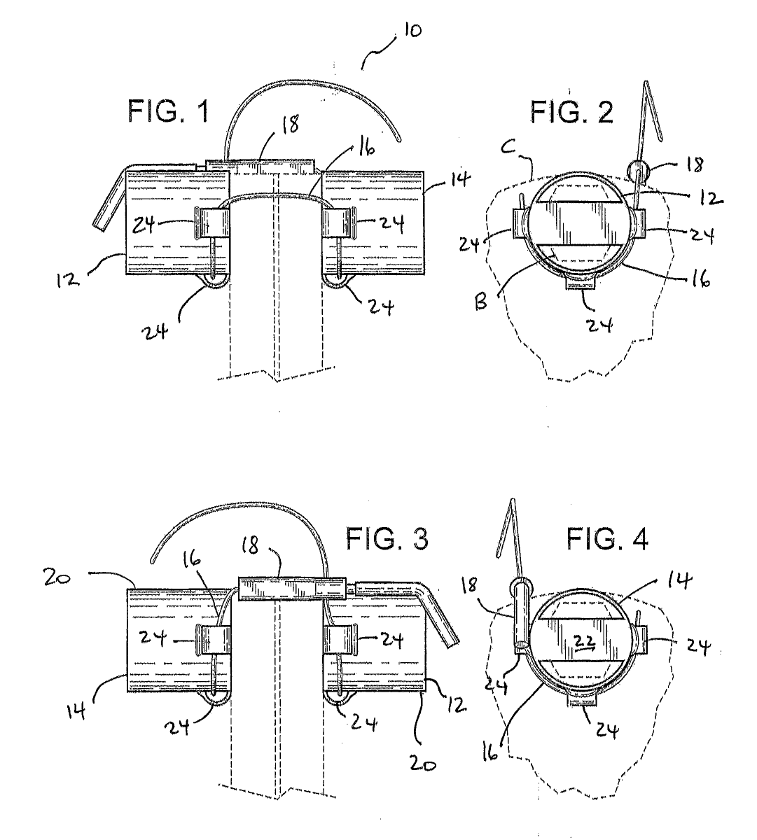

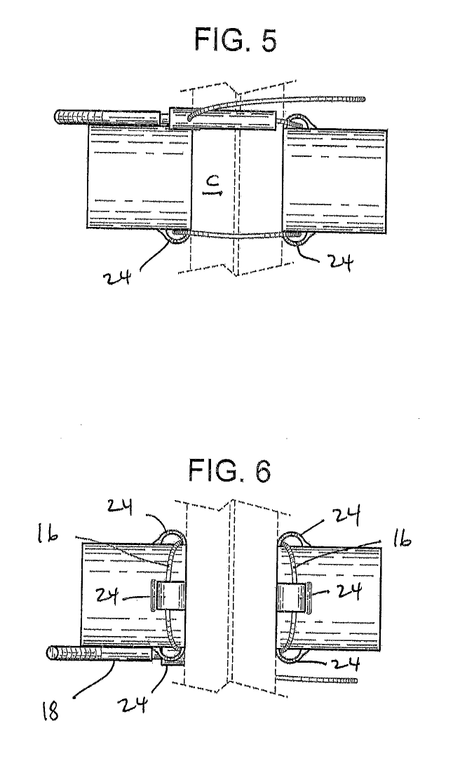

As shown in FIG. 1, each of the first bolt cup (12) and second bolt cup (14) is preferably a cylindrical-shaped socket which fits over a bolt head (B) or nut of the flange connection. Each should be fashioned from a rigid strong material, such as a metal, plastic or composite material, and closely fit the bolt head (B) or nut so it may only be removed by pulling the cup directly away from the bolt head or nut when the flange seal is installed. In one embodiment, if the bolt head or nut has a standard hexagonal shape, each cup may have a complementary hexagonal shape closely matched in size. However, it is not necessary to have identical or similar shapes. What is required is only that the cup cannot be removed once in position covering the bolt head or nut and secured into position with the flexible connector (16).

The outer end (20) of each the first and second bolt cups may be closed or left open. In one embodiment, a simple reinforcing band (22) may be attached across an open outer end, for structural strength, as shown in FIG. 1.

In one embodiment, each bolt cup (12, 14) has at least one, and preferably two or more shackles (24) through which the flexible connector (16) passes through. As shown in the Figures, in a preferred embodiment, each bolt cup has three shackles (24), and the flexible connector (16) loops through each of the shackles. As may be seen in the Figures, the flexible connector (16) loops around each bolt cup and when tightened, the flexible connector (16) prevents disengagement of the bolt cups from the flange bolt. The flexible connector (16) is tightened up against the circumference (C) of each flange. As such, the only way to access the flange bolt (B) is to cut the flexible connector (16), or disable the crimp connector (18).

While it may be relatively easy to cut the flexible connector or disable the crimp connector to access the shielded bolts or nuts, doing so will be a conscious step, and may prompt the user to reconsider whether this particular flange connection should be disconnected.

### DEFINITIONS AND INTERPRETATION

The description of the present invention has been presented for purposes of illustration and description, but it is not intended to be exhaustive or limited to the invention in the form disclosed. Many modifications and variations will be apparent to those of ordinary skill in the art without departing from the scope and spirit of the invention. Embodiments were chosen and described in order to best explain the principles of the invention and the practical application, and to enable others of ordinary skill in the art to understand the invention for various embodiments with various modifications as are suited to the particular use contemplated.

The corresponding structures, materials, acts, and equivalents of all means or steps plus function elements in the claims appended to this specification are intended to include any structure, material, or act for performing the function in combination with other claimed elements as specifically claimed.

References in the specification to “one embodiment”, “an embodiment”, etc., indicate that the embodiment described may include a particular aspect, feature, structure, or characteristic, but not every embodiment necessarily includes that aspect, feature, structure, or characteristic. Moreover, such phrases may, but do not necessarily, refer to the same embodiment referred to in other portions of the specification. Further, when a particular aspect, feature, structure, or characteristic is described in connection with an embodiment, it is within the knowledge of one skilled in the art to affect or connect such aspect, feature, structure, or characteristic with other embodiments, whether or not explicitly described. In other words, any element or feature may be combined with any other element or feature in different embodiments, unless there is an obvious or inherent incompatibility between the two, or it is specifically excluded.

It is further noted that the claims may be drafted to exclude any optional element. As such, this statement is intended to serve as antecedent basis for the use of exclusive terminology, such as “solely,” “only,” and the like, in connection with the recitation of claim elements or use of a “negative” limitation. The terms “preferably,” “preferred,” “prefer,” “optionally,” “may,” and similar terms are used to indicate that an item, condition or step being referred to is an optional (not required) feature of the invention.

The singular forms “a,” “an,” and “the” include the plural reference unless the context clearly dictates otherwise. The term “and/or” means any one of the items, any combination of the items, or all of the items with which this term is associated.

What is claimed is:

1. A flange sealing system comprising first and second bolt cups, each having at least one shackle and a flexible connector adapted to pass through the shackles, the flexible connector having an adjustable effective length, and the flexible connector adapted to be locked when shortened to a locking length so as to prevent a user from extending the length.

2. The flange sealing system of claim 1 wherein the flexible connector comprises a wire, cable, rope or tie.

3. The flange sealing system of claim 2 wherein the flexible connector comprises a crimp connector to lock the flexible connector.

4. The flange sealing system of claim 1 wherein the flexible connector forms a loop routed around each bolt cup when installed.

5. The flange sealing system of claim 1 wherein each bolt cup comprises two or more shackles.

6. The flange sealing system of claim 5 wherein each bolt cup comprises three shackles.

7. The flange sealing system of claim 3 wherein the crimp connector cannot be disconnected without damage or alteration.

8. The flange sealing system of claim 6 wherein the crimp connector comprises a unique identifier.

9. A method of securing a flange connection having an opposing bolt head and nut, comprising the steps of:
(a) installing a first bolt cup over the bolt head and a second bolt cup over the nut and securing a flexible connector through a first bolt cup shackle and a second bolt cup shackle;
(b) shortening the flexible connector to restrict movement of the first and second bolt cups;
(c) locking the flexible connector into its shortened length with a locking device,

10. The method of claim 9 wherein the locking device is a crimp connector,

11. The method of claim 9 wherein the flexible connector forms a loop routed around each bolt cup when installed.
